(19) United States
(12) Patent Application Publication
(10) Pub. No.: US 2015/0248008 A1
(43) Pub. Date: Sep. 3, 2015

(54) ACTUATOR, OPTICAL SCANNER, IMAGE DISPLAY APPARATUS, AND HEAD-MOUNTED DISPLAY

(71) Applicant: Seiko Epson Corporation, Tokyo (JP)

(72) Inventors: Makiko HINO, Matsumoto (JP); Yasushi MIZOGUCHI, Suwa (JP)

(21) Appl. No.: 14/633,623

(22) Filed: Feb. 27, 2015

(30) Foreign Application Priority Data
Feb. 28, 2014 (JP) 2014-038181

(51) Int. Cl. G02B 26/10; H02N 11/00; G02B 27/01

(52) U.S. Cl. CPC G02B 26/105; G02B 27/0172; G02B 26/101; H02N 11/006

(57) ABSTRACT

An actuator includes: a movable section; a support section; a first shaft that connects the movable section and the support section to each other and supports the movable section in a swingable manner around a first axis; an impact reduction section that is provided between the movable section and the support section and connected to the support section; and a restriction section so provided that the restriction section sandwiches the impact reduction section in a displacement direction in which the movable section is displaced when the movable section swings around the first axis.

### BACKGROUND

1. Technical Field

The present invention relates to an actuator, an optical scanner, an image display apparatus, and a head-mounted display.

2. Related Art

As a light deflector that deflects light, there is, for example, a known configuration including a mirror section having a mirror (light reflector), a support section so provided that it surrounds the mirror section, and torsion bars that connect the mirror section and the support section to each other and support the mirror section in a swingable manner around a predetermined axis. In the thus configured light deflector, when large impact is applied to the light deflector, for example, when it is dropped, the torsion bars are likely to experience breakage or other types of failure. Sufficient mechanical strength of the light deflector cannot therefore undesirably be provided.

To address the problem, JP-A-2009-169089 discloses a light deflector provided with impact reduction sections that face a pair of opposite sides of the mirror section in the direction perpendicular to the torsion bars. The impact reduction sections are connected to the support section. For example, when externally applied impact or vibration produces force that translates the mirror section in a direction perpendicular to the torsion bars (direction perpendicular to torsion bars in device surface including support section and other portions), the mirror section is allowed to hit one of the impact reduction sections so that a situation in which the mirror section hits the support section is avoided. Breakage of the light deflector is therefore avoided.

However, the mirror section having received externally applied impact or any other type of influence possibly swings around the torsion bars after the mirror section hits the impact reduction section. The present inventor has found that when the mirror section hits one of the impact reduction sections, the mirror section swings for a certain period while the mirror section remains in contact with the impact reduction section. During the behavior, the impact reduction section is prompted by the swing motion of the mirror section and displaced in the thickness direction of the device surface including the support section and other portions, that is, in the direction in which the mirror section is displaced. As a result, the impact reduction section is displaced beyond a limit, possibly resulting in degradation in the material of which the impact reduction section is made or breakage of the impact reduction section.

### SUMMARY

An advantage of some aspect of the invention is to provide an actuator, an optical scanner, an image display apparatus, and a head-mounted display having high impact resistance.

The invention can be implemented as the following application examples.

An actuator according to an application example of the invention includes a movable section, a support section, a first shaft that connects the movable section and the support section to each other and supports the movable section in a swingable manner around a first axis, an impact reduction section that is provided between the movable section and the support section and connected to the support section, and a restriction section so provided that the restriction section sandwiches the impact reduction section in a displacement direction in which the movable section is displaced when the movable section swings around the first axis.

According to the configuration described above, when the movable section is displaced in the displacement direction in accordance with impact applied to the actuator, and the impact reduction section is displaced accordingly in the displacement direction of the movable section, the impact reduction section comes into contact with the restriction section that prevents excessive displacement of the impact reduction section. As a result, breakage of the impact reduction section is avoided, whereby impact resistance of the actuator can be increased. Therefore, according to the configuration described above, an actuator having high impact resistance can be provided.

In the actuator according to the application example of the invention, it is preferable that the restriction section restricts displacement of the impact reduction section in the displacement direction.

In the configuration described above, the restriction section can restrict excessive displacement of the impact reduction section as well as that of the movable section. As a result, breakage of the impact reduction section can be avoided.

In the actuator according to the application example of the invention, it is preferable that, when a flat plane including the first axis and the impact reduction section is defined to be a reference plane, the restriction section is provided in a position where the restriction section does not overlap with the movable section in a plan view viewed in a direction perpendicular to the reference plane.

In the configuration described above, when the movable section swings, contact between the movable section and the restriction section is avoided. As a result, interference of the restriction section with the swing motion of the movable section is avoided, whereby a stable swing motion of the movable section is achieved.

In the actuator according to the application example of the invention, it is preferable that the impact reduction section includes a first portion and a second portion that has bending rigidity smaller than the bending rigidity of the first portion and connects the first portion to the support section.

In the configuration described above, in which the movable section is caused to come into contact with the first portion, the first portion is displaced in the displacement direction and comes into contact with the restriction section before the second portion. The first portion having relatively large bending rigidity is therefore caused to first come into contact with the restriction section, whereby breakage of the impact reduction section is avoided and the displacement of the impact reduction section can be restricted at the same time.

In the actuator according to the application example of the invention, it is preferable that, when a flat plane including the first axis and the impact reduction section is defined to be a reference plane, part of the first portion extends off the restriction section in a plan view viewed in a direction perpendicular to the reference plane.

Since the first portion is therefore allowed to more reliably come into contact with the restriction section, breakage of the impact reduction section due to possible contact between the second portion and the restriction section can be more reliably avoided.

In the actuator according to the application example of the invention, it is preferable that the movable section, the support section, the first shaft, and the impact reduction section are formed integrally with each other.

As a result, the actuator can be formed with increased dimension precision, and the size of the actuator can be reduced.

In the actuator according to the application example of the invention, it is preferable that the movable section has a first movable portion, a second movable portion that has a frame-like shape that surrounds the first movable portion, and a second shaft that connects the first movable portion to the second movable portion and supports the first movable portion in a swingable manner relative to the second movable portion around a second axis that intersects the first axis.

The first movable portion is therefore allowed to swing around the two axes.

An optical scanner according to an application example of the invention includes a movable section including a light reflector that reflects light, a support section, a first shaft that connects the movable section and the support section to each other and supports the movable section in a swingable manner around a first axis, an impact reduction section that is provided between the movable section and the support section and connected to the support section, and a restriction section so provided that the restriction section sandwiches the impact reduction section in a displacement direction in which the movable section is displaced when the movable section swings around the first axis.

According to the configuration described above, when the movable section is displaced in the displacement direction in accordance with impact applied to the optical scanner, and the impact reduction section is displaced accordingly in the displacement direction, the impact reduction section comes into contact with the restriction section that prevents excessive displacement of the impact reduction section. As a result, breakage of the impact reduction section is avoided, whereby impact resistance of the optical scanner can be increased. Therefore, according to the configuration described above, an optical scanner having high impact resistance can be provided.

An image display apparatus according to an application example of the invention includes a movable section including a light reflector that reflects light, a support section, a first shaft that connects the movable section and the support section to each other and supports the movable section in a swingable manner around a first axis, an impact reduction section that is provided between the movable section and the support section and connected to the support section, and a restriction section so provided that the restriction section sandwiches the impact reduction section in a displacement direction in which the movable section is displaced when the movable section swings around the first axis.

According to the configuration described above, when the movable section is displaced in the displacement direction in accordance with impact applied to the image display apparatus, and the impact reduction section is displaced accordingly in the displacement direction, the impact reduction section comes into contact with the restriction section that prevents excessive displacement of the impact reduction section. As a result, breakage of the impact reduction section is avoided, whereby impact resistance of the image display apparatus can be increased. Therefore, according to the configuration described above, an image display apparatus having high impact resistance and high reliability can be provided.

A head-mounted display according to an application example of the invention includes a frame worn around a head of a viewer and an optical scanner provided in the frame, and the optical scanner includes a movable section including a light reflector that reflects light, a support section, a first shaft that connects the movable section and the support section to each other and supports the movable section in a swingable manner around a first axis, an impact reduction section that is provided between the movable section and the support section and connected to the support section, and a restriction section so provided that the restriction section sandwiches the impact reduction section in a displacement direction in which the movable section is displaced when the movable section swings around the first axis.

According to the configuration described above, when the movable section is displaced in the displacement direction in accordance with impact applied to the head-mounted display, and the impact reduction section is displaced accordingly in the displacement direction, the impact reduction section comes into contact with the restriction section that prevents excessive displacement of the impact reduction section. As a result, breakage of the impact reduction section is avoided, whereby impact resistance of the head-mounted display can be increased. Therefore, according to the configuration described above, a head-mounted display having high impact resistance and high reliability can be provided.

### BRIEF DESCRIPTION OF THE DRAWINGS

The invention will be described with reference to the accompanying drawings, wherein like numbers reference like elements.

FIG. 1 is a configuration diagram showing an image display apparatus according to a first embodiment of the invention.

FIG. 2 is a perspective view of an optical scanner provided in the image display apparatus shown in FIG. 1.

FIG. 3 is a top view of the optical scanner shown in FIG. 2.

FIG. 4 is a cross-sectional view taken along the line A-A in FIG. 3.

FIGS. 5A and 5B show voltages applied to a coil shown in FIG. 4.

FIGS. 6A and 6B are a top view and a cross-sectional view respectively for describing the function of a restriction section provided in the optical scanner shown in FIG. 2.

FIGS. 7A and 7B are a top view and a cross-sectional view respectively for describing the function of the restriction section provided in the optical scanner shown in FIG. 2.

FIGS. 8A and 8B are a top view and a cross-sectional view respectively for describing the function of the restriction section provided in the optical scanner shown in FIG. 2.

FIGS. 9A and 9B are a top view and a cross-sectional view respectively for describing the function of the restriction section provided in the optical scanner shown in FIG. 2.

FIG. 10 is a configuration diagram showing an image display apparatus according to a second embodiment of the invention.

FIG. 11 is a top view of an optical scanner provided in the image display apparatus shown in FIG. 10.

FIG. 12 is a cross-sectional view taken along the line D-D in FIG. 11.

FIG. 13 is a top view of an optical scanner provided in an image display apparatus according to a third embodiment of the invention.

FIG. 14 is a cross-sectional view taken along the line E-E in FIG. 13.

FIG. 15 is a perspective view showing a head-up display that is an application of the image display apparatus according to any of the embodiments of the invention.

FIG. 16 is a perspective view showing a head-mounted display according to an embodiment of the invention.

### DESCRIPTION OF EXEMPLARY EMBODIMENTS

An actuator, an optical scanner, an image display apparatus, and a head-mounted display according to preferable embodiments of the invention will be described below with reference to the accompanying drawings.

### 1. Optical Scanner (Actuator)

An optical scanner according to an embodiment of the invention (actuator according to an embodiment of the invention) will first be described.

### First Embodiment

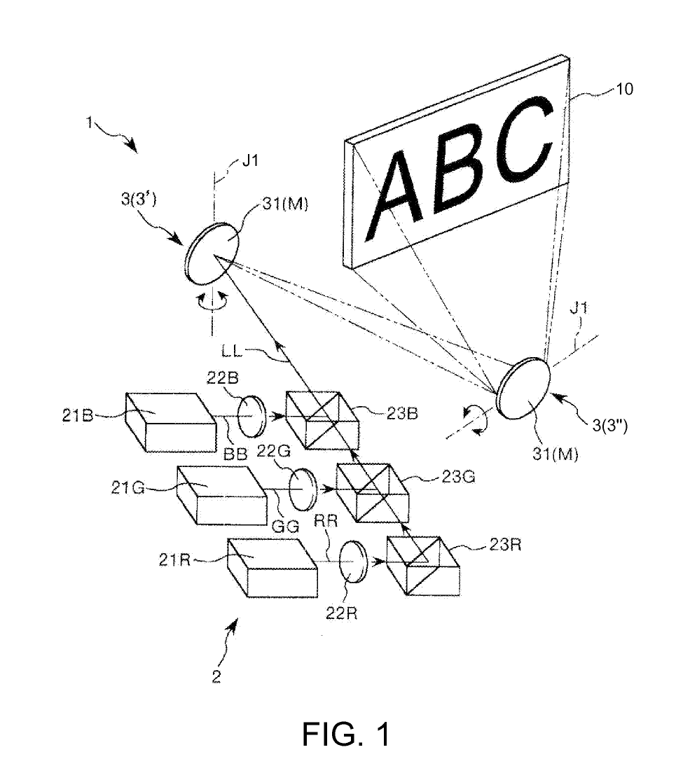

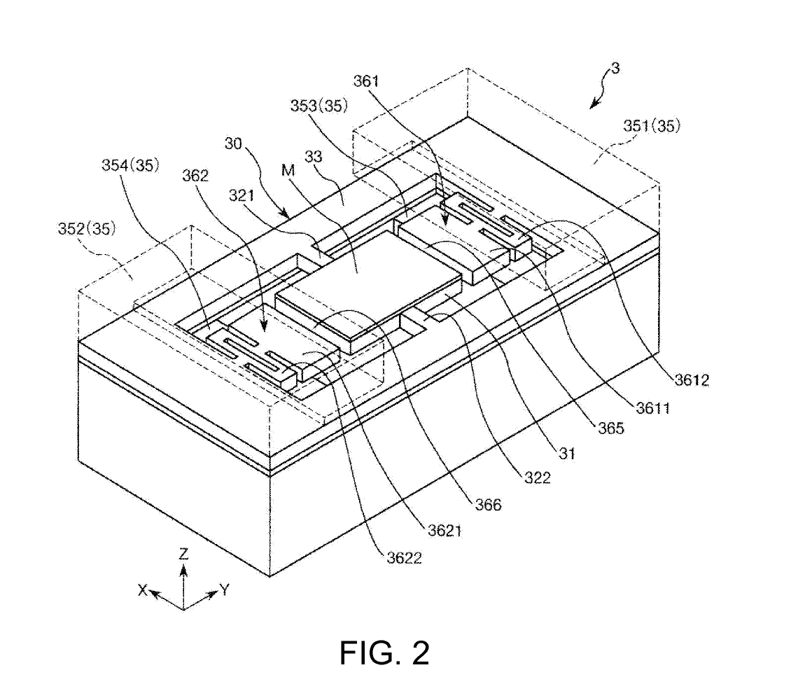

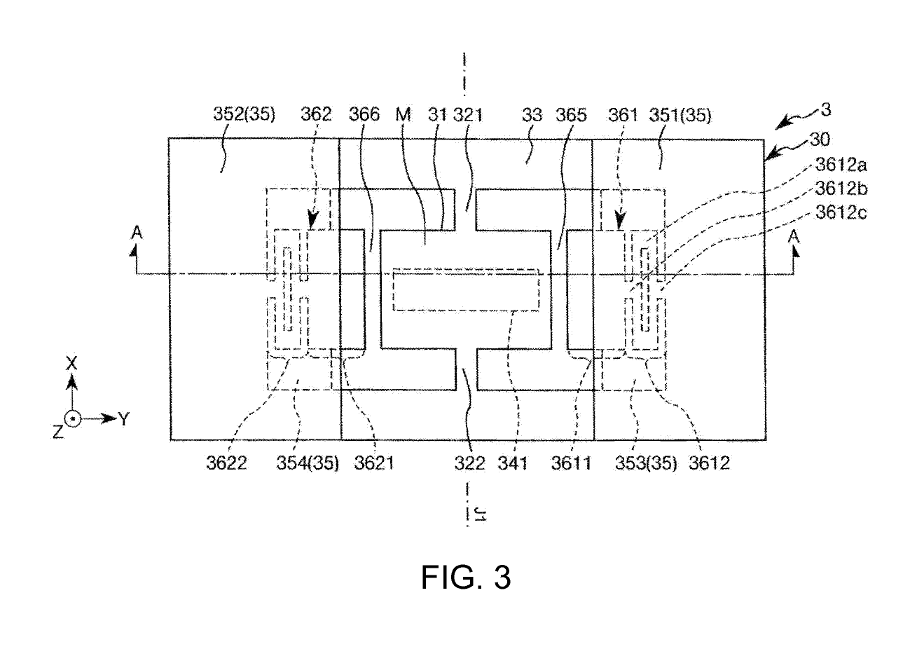

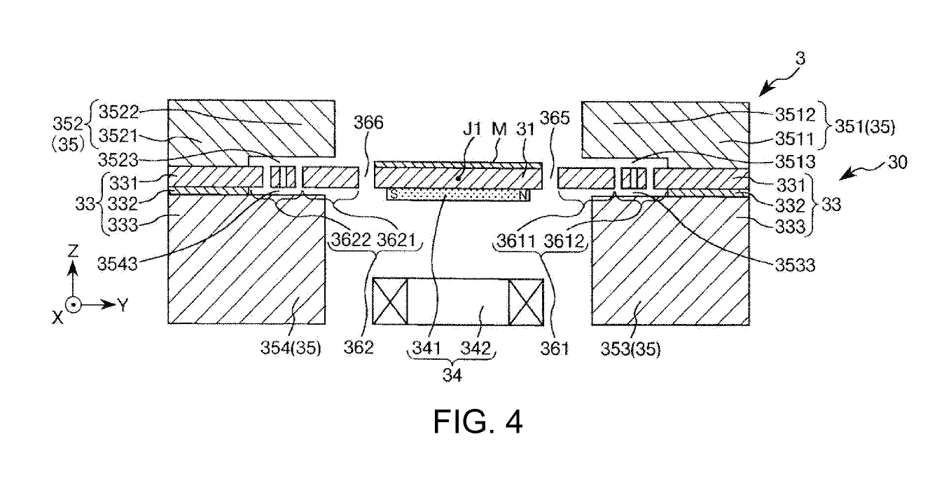

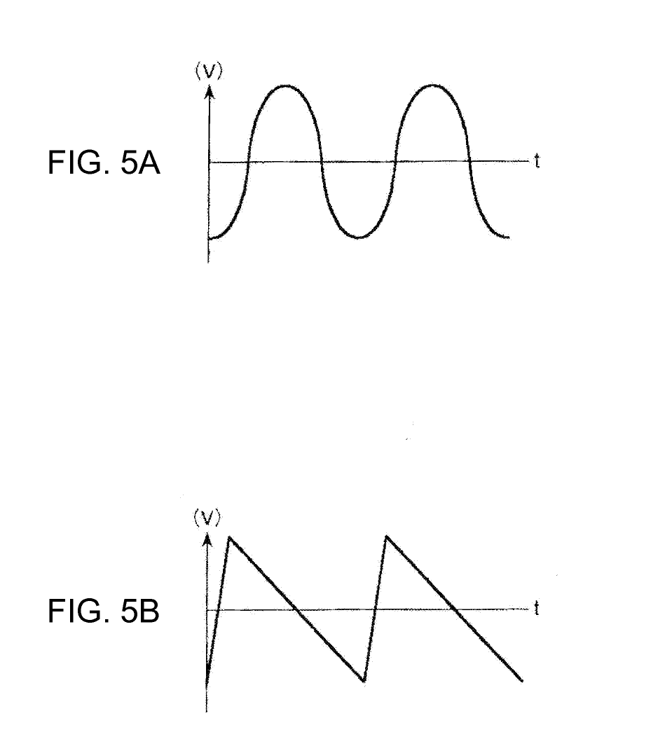

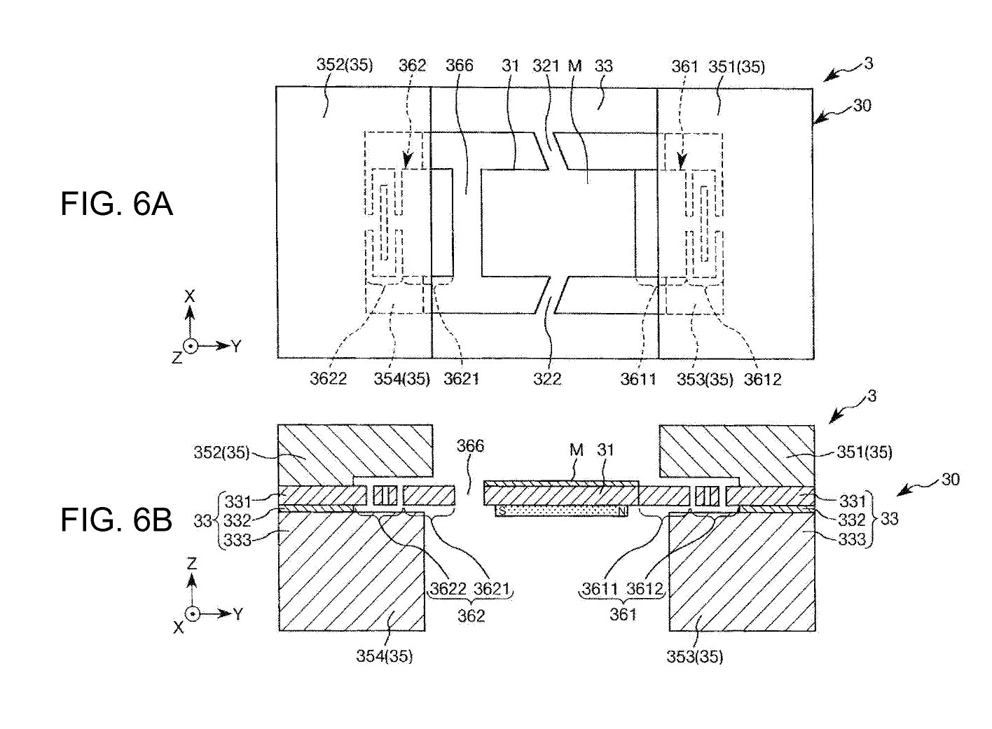

FIG. 1 is a configuration diagram showing an image display apparatus according to a first embodiment of the invention. FIG. 2 is a perspective view of an optical scanner provided in the image display apparatus shown in FIG. 1. FIG. 3 is a top view of the optical scanner shown in FIG. 2. FIG. 4 is a cross-sectional view taken along the line A-A in FIG. 3. FIGS. 5A and 5B show voltages applied to a coil shown in FIG. 4. FIGS. 6A and 6B to FIGS. 9A and 9B are top views and cross-sectional views respectively for describing the function of a restriction section provided in the optical scanner shown in FIG. 2. In the following description, the side toward the reader with respect to the plane of view of FIG. 3 is called an “upper” side, and the side away from the reader with respect to the plane of view of FIG. 3 is called a “lower” side for ease of description. Further, the cross-sectional views of FIGS. 6B to 9B are taken along lines corresponding to the line A-A in FIG. 3 among the other top views of FIGS. 6A to 9A.

An image display apparatus 1 is an apparatus that two-dimensionally scans an object 10, such as a careen and a wall surface, with drawing laser light LL to display an image on the object 10, as shown in FIG. 1. The image display apparatus 1 includes a drawing light source unit 2, which outputs the drawing laser light LL, and two optical scanners 3, which scan the object 10 with the drawing laser light LL. In the thus configured image display apparatus 1, the two optical scanners 3 are so disposed that the scan directions in which the optical scanners 3 scan the object 10 with the drawing laser light LL (first axes J1, which will be described later) are perpendicular to each other. Further, for example, one of the optical scanners 3 scans the object 10 with the drawing laser light LL in the horizontal direction, and the other optical scanner 3 scans the object 10 with the drawing laser light LL in the vertical direction, whereby a two-dimensional image can be displayed on the object 10. In the following description, the optical scanner 3 that scans the object 10 with the drawing laser light LL in the horizontal direction is also called a “horizontal-scan optical scanner 3′,” and the optical scanner 3 that scans the object 10 with the drawing laser light LL in the vertical direction is also called a “vertical-scan optical scanner 3″.”

### Drawing Light Source Unit

The drawing light source unit 2 includes red, green, and blue laser light sources (light source sections) 21R, 21G, and 21B, collimator lenses 22R, 22G, and 22B, and dichroic mirrors 23R, 23G, and 23B, which are provided in correspondence with the laser light sources 21R, 21G, and 21B, as shown in FIG. 1.

Each of the laser light sources 21R, 21G, and 21B has a light source and a drive circuit neither of which is shown. The laser light source 21R emits red laser light RR. The laser light source 21G emits green laser light GG. The laser light source 21B emits blue laser light BB. The laser light beams RR, GG, and BB are emitted in correspondence with drive signals transmitted from a controller that is not shown and parallelized or substantially parallelized by the collimator lenses 22R, 22G, and 22B, respectively. Each of the laser light sources 21R, 21G, and 21B can, for example, be an end-surface-emitting semiconductor laser, a surface-emitting semiconductor laser, or any other semiconductor laser. Using a semiconductor laser allows size reduction of each of the laser light sources 21R, 21G, and 21B.

The dichroic mirrors 23R, 23G, and 23B are arranged in accordance with the arrangement of the thus configured laser light sources 21R, 21G, and 21B. The dichroic mirror 23R is characterized in that it reflects the laser light RR. The dichroic mirror 23G is characterized in that it reflects the laser light GG and transmits the laser light RR. The dichroic mirror 23B is characterized in that it reflects the laser light BB and transmits the laser light RR and the laser light GG. The dichroic mirrors 23R, 23G, and 23B combine the color laser light beams RR, GG, and BB with one another into the drawing laser light LL.

### Optical Scanners

Each of the optical scanners 3 shown in FIGS. 2 to 4 includes a structural part 30, which has a movable section 31, which has a light reflector M, a pair of shafts (first shafts) 321 and 322, a support section 33, and a pair of impact reduction sections 361 and 362, a drive unit 34, which causes the movable section 31 to swing, and a restriction section 35, which restricts (limits) excessive displacement of the impact reduction sections 361 and 362. A configuration in which the light reflector M is removed from the thus configured optical scanner 3 corresponds to an actuator according to an embodiment of the invention.

In the following description, it is assumed for ease of description that an X axis, a Y axis, and a Z axis are three axes perpendicular to each other, that the Z-axis direction coincides with the thickness direction of the movable section (structural part 30), and that the X-axis direction coincides with the first axis J1. Further, in the following description, a plan view viewed along the Z-axis direction is also simply called a “plan view.” Moreover, a flat plane containing a plane over which the structural part 30 extends is also called a “reference plane.” The Z axis is perpendicular to the reference plane. In FIGS. 2 and 3, part of the optical scanner is shown in a perspective manner.

The movable section 31 has a plate-like shape, and the light reflector M, which has light reflectivity, is provided on the upper surface of the movable section 31. The light reflector M can be formed, for example, of a metal film made, for example, of aluminum. The drawing laser light LL is incident on the thus formed movable section 31, reflected off the light reflector M, and deflected in a direction according to the attitude of the light reflector M (movable section 31).

The movable section 31 in the plan view does not necessarily have a rectangular shape shown in FIGS. 2 and 3 and may instead have a square, polygonal, circular, or any other shape.

The shafts 321 and 322 are disposed on opposite sides of the movable section 31 in the X-axis direction. Further, each of the shafts 321 and 322 extends along the first axis J1, and one end of the shaft is connected to the movable section 31 and the other end of the shaft is connected to the support section 33. Each of the shafts 321 and 322 supports the movable section 31 in a swingable manner around the first axis and torsionally deforms in accordance with the swing motion of the movable section 31 around the first axis J1. Each of the shafts 321 and 322 does not necessarily have the shape described above and may, for example, have at least one bent or curved middle portion or at least one split middle portion. Each of the shafts 321 and 322 may instead be divided into two shafts.

The support section 33 has a frame-like shape and is so disposed that it surrounds the movable section 31 in the plan view. The support section 33 is not necessarily configured as described above and may, for example, be configured as follows: The support section 33 is divided into four portions; two of the four portions are disposed on opposite sides of the movable section 31 in the X-axis direction and the shafts 321 and 322 are connected to the two portions; and the remaining two portions are disposed on opposite sides of the movable section 31 in the Y-axis direction and the impact reduction sections 361 and 362 are connected to the remaining two portions.

The impact reduction sections 361 and 362 are disposed on opposite sides of the movable section 31 in the Y-axis direction. Further, the impact reduction sections 361 and 362 are connected to the support section 33 and protrude toward the interior of the support section 33. In other words, the impact reduction sections 361 and 362 are so provided that they protrude from the support section 33 toward the movable section 31.

The impact reduction section 361 and the movable section 31 are separate from each other via an air gap 365, and the impact reduction section 362 and the movable section 31 are separate from each other via an air gap 366. Therefore, when the movable section 31 swings with no external impact or any other type of influence applied thereto (this state is hereinafter also referred to as “steady state”), the movable section 31 will not come into contact with the impact reduction section 361 or 362, and a situation in which the impact reduction sections 361 and 362 prevent the movable section 31 from swinging is avoided.

On the other hand, when external impact or any other type of influence is applied to the optical scanner 3, the movable section 31 is displaced in the Y-axis direction due to the impact in some cases. The movable section 31 then hits the impact reduction section 361 or 362 so that further displacement of the movable section 31 in the Y-axis direction is restricted. The displacement restriction prevents breakage of the movable section 31 or the support section 33 due to direct contact between the movable section 31 and the support section 33, degradation of characteristics of the optical scanner 3 due to excessive pulling of the shafts 321 and 322, and other problems.

The impact reduction section 361 has a first portion 3611, which is adjacent to the movable section 31 via the air gap 365 in the Y-axis direction, and a second portion 3612, which is so provided that it connects the first portion 3611 to the support section 33 and has bending rigidity smaller than that of the first portion 3611. When the movable section 31 is displaced in the Y-axis direction, for example, rightward in FIG. 4, the movable section 31 comes into contact with the first portion 3611, whereby the first portion 3611 can receive energy of the displacement of the movable section 31, and the second portion 3621 can absorb the energy of the displacement. As a result, the displacement of the movable section 31 in the Y-axis direction is restricted, whereby breakage of the movable section 31 is avoided.

The same holds true for the impact reduction section 362. The impact reduction section 362 has a first portion 3621, which is adjacent to the movable section 31 via the air gap 366 in the Y-axis direction, and a second portion 3622, which is so provided that it connects the first portion 3621 to the support section 33 and has bending rigidity smaller than that of the first portion 3621. When the movable section 31 is displaced in the Y-axis direction, for example, leftward in FIG. 4, the movable section 31 comes into contact with the first portion 3621, whereby the first portion 3621 can receive energy of the displacement of the movable section 31, and the second portion 3622 can absorb the energy of the displacement. As a result, the displacement of the movable section 31 in the Y-axis direction is restricted, whereby breakage of the movable section 31 is avoided.

The impact reduction sections 361 and 362 only need to have a function of at least restricting the displacement of the movable section 31 in the Y-axis direction and do not necessarily have the above-mentioned function of absorbing impact when the movable section 31 comes into contact with the impact reduction section 361 or 362.

The thus configured structural part 30 is integrally formed, for example, by etching an SOI substrate [substrate having first Si layer (device layer), SiO₂ layer (box layer), and second Si layer (handle layer) layered on each other in this order]. Specifically, in the structural part 30, the first Si layer of the SOI substrate forms the movable section 31, the shafts 321 and 322, and the impact reduction sections 361 and 362. A laminate of the first Si layer (first support portion 331 in FIG. 4), the SiO₂ layer (second support portion 332 in FIG. 4), and the second Si layer (third support portion 333 in FIG. 4) of the SOI substrate forms the support section 33. Therefore, looking only at the first Si layer (device layer), it can be said that the movable section 31, the support section 33, the shafts 321 and 322, and the impact reduction sections 361 and 362 are formed integrally with each other. Forming the structural part 30 by using the SOI substrate as described above allows the optical scanner 3 to have excellent oscillation characteristics. Further, since the SOI substrate can be minutely processed in an etching process, forming the structural part 30 by using the SOI substrate provides excellent dimension precision of the structural part 30. Moreover, the size of the optical scanner 3 can be reduced.

The drive unit 34 includes a permanent magnet 341, which is provided on the lower surface of the movable section 31, and a coil 342, which is so disposed that it faces the permanent magnet 341, as shown in FIG. 4. The permanent magnet 341 is so disposed in the plan view that the N pole thereof is located on one side of the first axis J1 (+Y-axis side), and the S pole thereof is located on the other side of the first axis J1 (−Y-axis side). The permanent magnet 341 can, for example, preferably be a neodymium magnet, a ferrite magnet, a samarium-cobalt magnet, an Alcoa magnet, or a bonded magnet.

The thus configured drive unit 34 allows the movable section 31 to swing around the first axis J1 when an alternate voltage is applied to the coil 342. Specifically, when an alternate voltage is applied to the coil 342, the following two magnetic fields are alternately produced around the coil 342: a first magnetic field that attracts the N pole of the permanent magnet 341 toward the coil 342 and repels the S pole of the permanent magnet 341 away from the coil 342; and a second magnetic field that repels the N pole of the permanent magnet 341 away from the coil 342 and attracts the S pole of the permanent magnet 341 to the coil 342 in contrast to the first magnetic field. The first and second magnetic fields, one of which is switched to the other and vice versa, can cause the shafts 321 and 322 to be torsionally deformed and the movable section 31 to swing around the first axis J1.

The coil 342 may instead be disposed on an upper surface of any other member that is not shown. Still instead, when the optical scanner 3 includes a substrate (not shown) that supports the entire lower surface of the support section 33 that includes the interior space thereof, the coil 342 may be disposed on the upper surface of the substrate.

The horizontal-scan optical scanner 3′ of the two optical scanners 3 preferably allows the movable section 31 to undergo resonant oscillation when an alternate voltage having a frequency equal to the torsional resonance frequency of the oscillation system formed of the movable section 31 and the shafts 321 and 322 is applied to the coil 342. The resonant oscillation allows the movable section 31 to swing around the first axis J1 by a large angle. The frequency of the alternate voltage is not particularly limited to a specific value but preferably ranges from, for example, about 10 to 40 kHz. Further, the waveform of the alternate voltage is not particularly limited to a specific shape but is preferably a sinusoidal waveform, such as that shown in FIG. 5A.

On the other hand, the vertical-scan optical scanner 3″ preferably allows the movable section 31 to undergo non-resonant oscillation when an alternate voltage having a frequency different from the torsional resonance frequency of the oscillation system formed of the movable section 31 and the shafts 321 and 322 is applied to the coil 342. The frequency of the alternate voltage is not particularly limited to a specific value but preferably ranges from, for example, about 30 to 120 Hz (about 60 Hz). Further, the waveform of the alternate voltage is not particularly limited to a specific shape but is preferably a sawtooth waveform, such as that shown in FIG. 5B.

The restriction section 35 prevents excessive displacement of the impact reduction sections 361 and 362 in the Z-axis direction induced when impact (acceleration in Y-axis direction) is applied to the optical scanner 3, for example, when it is dropped. Breakage of the optical scanner (breakage of impact reduction sections 361 and 362, in particular) can thus be avoided. Providing the thus configured restriction section 35 can improve impact resistance of the optical scanner 3.

The restriction section 35 according to the present embodiment includes a first restriction portion 351, which has a portion that extends in such a way that it overhangs the impact reduction section 361, and a first restriction portion 352, which similarly has a portion that extends in such a way that it overhangs the impact reduction section 362. The first restriction portions 351 and 352 have a function of restricting excessive upward (+Z-axis-side) displacement of the impact reduction sections 361 and 362.

On the other hand, the restriction section 35 according to the present embodiment includes a second restriction portion 353, which is connected to the third support portion 333 and extends under the impact reduction section 361, and a second restriction portion 354, which is similarly connected to the third support portion 333 and extends under the impact reduction section 362. The second restriction portions 353 and 354 have a function of restricting excessive downward (−Z-axis-side) displacement of the impact reduction sections 361 and 362.

The first restriction portions 351 and 352 are disposed along the Y axis and separate from each other with the movable section 31 therebetween in the plan view.

The first restriction portion 351 is divided into a base portion 3511, which overlaps with part of the support section 33 in the plan view, and an extending portion 3512, which extends from the base portion 3511 along the Y axis toward the first restriction portion 352. The base portion 3511 is bonded to the upper surface of the support section 33 and is responsible for fixation of the first restriction portion 351. The thickness of the extending portion 3512 (length in Z-axis direction) is smaller than the thickness of the base portion 3511. As a result, an air gap 3513, which corresponds to the difference in thickness between the extending portion 3512 and the base portion 3511, is formed below the extending portion 3512. The impact reduction section 361 and the first restriction portion 351 are separate from each other via the air gap 3513.

Similarly, the first restriction portion 352 is divided into a base portion 3521, which overlaps with part of the support section 33 in the plan view, and an extending portion 3522, which extends from the base portion 3521 along the Y axis toward the first restriction portion 351. The base portion 3521 is bonded to the upper surface of the support section 33 and is responsible for fixation of the first restriction portion 352. The thickness of the extending portion 3522 (length in Z-axis direction) is smaller than the thickness of the base portion 3521. As a result, an air gap 3523, which corresponds to the difference in thickness between the extending portion 3522 and the base portion 3521, is formed below the extending portion 3522. The impact reduction section 362 and the first restriction portion 352 are separate from each other via the air gap 3523.

The second restriction portions 353 and 354 are also disposed along the Y axis and are separate from each other with the movable section 31 therebetween in the plan view.

The second restriction portion 353 is formed integrally with the third support portion 333. An air gap 3533, which is as thick as the second support portion 332, is provided between the impact reduction section 361 and the second restriction portion 353. The impact reduction section 361 and the second restriction portion 353 are separate from each other via the air gap 3533.

Similarly, the second restriction portion 354 is formed integrally with the third support portion 333. An air gap 3543, which is as thick as the second support portion 332, is provided between the impact reduction section 362 and the second restriction portion 354. The impact reduction section 362 and the second restriction portion 354 are separate from each other via the air gap 3543.

Therefore, the first restriction portion 351 and the second restriction portion 353 are so provided that they sandwich the impact reduction section 361 via the air gaps 3513 and 3533. On the other hand, the first restriction portion 352 and the second restriction portion 354 are so provided that they sandwich the impact reduction section 362 via the air gaps 3523 and 3543.

The thus configured restriction section 35 has a function of preventing excessive displacement of the impact reduction sections 361 and 362 in the Z-axis direction and hence breakage of the optical scanner 3, as described above. The function will be described below in detail.

As an example of the externally applied impact, a description will be made of a case where impact that displaces the movable section 31 rightward (+Y-axis side) is applied to the movable section 31, as shown in FIGS. 6A and 6B. In the following description, the impact reduction section 361 will be primarily described, and the same holds true for the impact reduction section 362. In this example, when the impact is applied to the optical scanner 3, the shafts 321 and 322 are stretched, and the movable section 31 is displaced rightward and first comes into contact with the first portion 3611 of the impact reduction section 361, as shown in FIGS. 6A and 6B. The contact can reduce the speed at which the movable section 31 is displaced rightward.

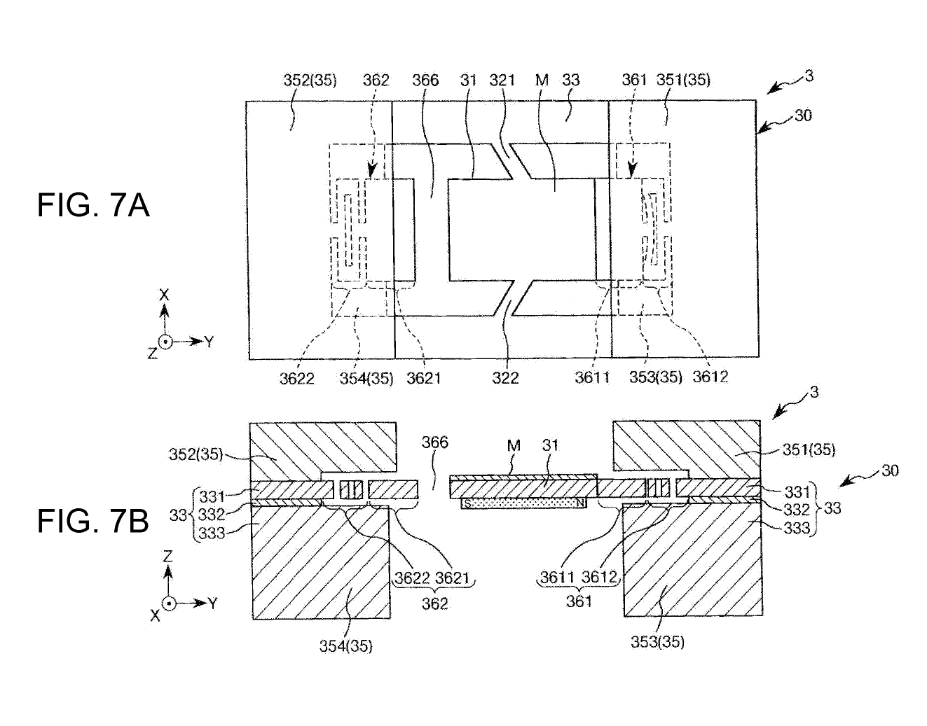

Subsequently, the movable section 31 keeps pushing the first portion 3611 rightward while being displaced at reduced speeds. The first portion 3611 is therefore displaced rightward along with the movable section 31. At the same time, the second portion 3612, the bending rigidity of which is relatively smaller than that of the first portion 3611, is compressed toward the +Y-axis side, as shown in FIGS. 7A and 7B. In this process, the energy of the displacement of the movable section 31 is absorbed by the compression action of the second portion 3612 to some extent. The amount of impact as a reaction acting on the movable section 31 from the second portion 3612 is therefore reduced, and any further displacement of the movable section 31 toward the +Y-axis side is restricted.

The example shown in FIGS. 6A and 6B shows the case where impact that displaces the movable section 31 toward the +Y-axis side along the Y-axis direction is applied to the movable section 31, but it is actually rare that the movable section 31 is displaced (impact is applied) along the direction completely parallel to the Y-axis direction, and it is believed that the displacement is likely to include not only the component in the Y-axis direction but also the components in the X-axis direction and the Z-axis direction.

In this case, after the energy of the displacement in the Y-axis direction is absorbed by the second portion 3612 to some extent as described above, the movable section 31 starts being displaced in the X-axis direction and swinging around the first axis J1. In this process, since the movable section 31 is displaced and swings for a certain period while the movable section 31 remains in contact with the first portion 3611, the impact reduction section 361 also starts being displaced in the X-axis direction and the Z-axis direction along with the movable section 31.

The energy of the displacement of the impact reduction section 361 in the X-axis direction is absorbed by compression or stretch action of the shafts 321 and 322, which support the movable section 31 being displaced at the same time, or absorbed by the bend action of the impact reduction section 361. Since the movable section 31 is surrounded by the frame-shaped support section 33, it is conceivable that the displacement in the X-axis direction is relatively readily restricted. As a result, the displacement in the X-axis direction settles relatively early and is therefore unlikely to cause breakage of the optical scanner 3.

On the other hand, the energy of the displacement in the Z-axis direction is absorbed to some extent by the stretch action of the shafts 321 and 322 and the bend action of the impact reduction section 361. If the displacement in the Z-axis direction is not restricted, however, the impact reduction section 361 is likely to be displaced by a large amount within the range over which the movable section 31 swings. As a result, the amount of displacement of the impact reduction section 361 in the Z-axis direction excessively increases, possibly resulting in breakage of the impact reduction section 361.

To avoid the situation described above, in the embodiment of the invention, the restriction section 35 is provided to prevent excessive displacement of the impact reduction section 361 in the Z-axis direction.

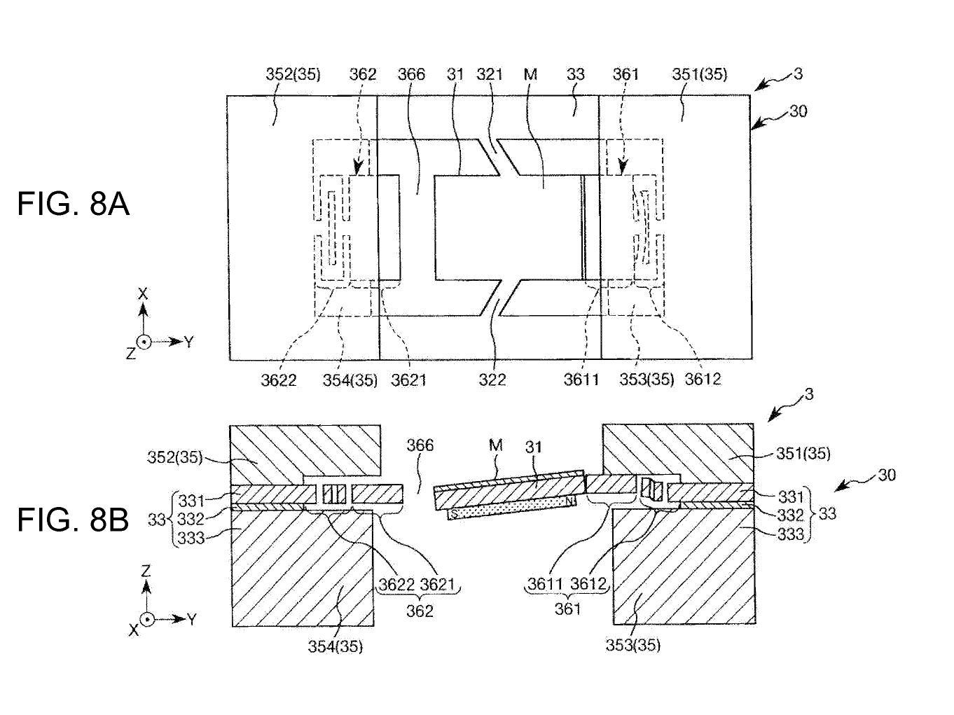

In the following sections, as an example of the displacement of the impact reduction section 361 in the Z-axis direction, a description will be made of a case where part of the movable section 31, specifically, an end portion thereof on the side facing the impact reduction section 361 swings with displacement toward the +Z-axis side as shown in FIGS. 8A and 8B. In this example, since the end portion of the movable section 31 on the side facing the impact reduction section 361 is displaced toward the +Z-axis side when the movable section swings (that is, “displacement direction” is Z-axis direction), the impact reduction section 361 is also displaced toward the +Z-axis side, as shown in FIG. 8B. In this process, since the first portion 3611 of the impact reduction section 361 is displaced while the first portion 3611 remains in contact with the swinging movable section 31, the first portion 3611 is displaced by the greatest amount among the portions of the impact reduction section 361 that are concurrently displaced. On the other hand, the second portion 3612 is bent in the Z-axis direction in accordance with the behavior of the first portion 3611.

The first portion 3611 of the impact reduction section 361 having been displaced toward the +Z-axis side then enters the air gap 3513 and eventually comes into contact with the extending portion 3512 of the first restriction portion 351, as shown in FIG. 8B. Further displacement of the impact reduction section 361 toward the +Z-axis side is therefore restricted. As a result, excessive displacement of the impact reduction section 361 in the Z-axis direction is restricted, whereby breakage of the impact reduction section 361 is avoided. No breakage of the impact reduction section 361 results in improvement in impact resistance of the optical scanner 3.

Since the displacement of the impact reduction section 361 in the Z-axis direction is induced by the swing motion of the movable section 31 as described above, restricting excessive displacement of the impact reduction section 361 in the Z-axis direction restricts excessive swing motion of the movable section 31 and excessive translation of the movable section 31 in the Z-axis direction. As a result, breakage of the shafts 321 and 322 is avoided, whereby the impact resistance of the optical scanner 3 can be increased.

The first portion 3611 of the impact reduction section 361 is displaced toward the +Z-axis side and comes into contact with the first restriction portion 351 before the second portion 3612, as described above. The first portion 3611 has bending rigidity relatively greater than that of the second portion 3612, as described above. The configuration in which the first portion 3611 comes into contact with the first restriction portion 351 before the second portion 3612 therefore prevents breakage of the impact reduction section 361 due to the contact. In other words, since the first portion 3611 is superior to the second portion 3612 in terms of durability against impact, the configuration in which the first portion 3611 first comes into contact with the first restriction portion 351 can prevent breakage of the impact reduction section 361 and restrict the displacement of the impact reduction section 361 at the same time.

Further, the second portion 3612 of the impact reduction section 361 has bending rigidity smaller than that of the first portion 3611. Therefore, when the first portion 3611 is displaced and comes into contact with the first restriction portion 351, the impact reduction section 361 is unlikely to be broken because the second portion 3612 readily bends. In other words, since the second portion 3612 can readily follow the displacement of the first portion 3611, it can be said that the impact reduction section 361 has large deformation capability and low breakage probability. High followability of the impact reduction section 361 enhances an advantageous effect of restriction of excessive swing motion of the movable section 31 and excessive translation thereof in the Z-axis direction.

The bending rigidity of the first portion 3611 and the second portion 3612 is, for example, bending resistance of the first portion 3611 under displacement of the first portion 3611 in the Z-axis direction and can be compared and evaluated in terms of magnitude of a load necessary for a predetermined amount of bending.

In the plan view of the optical scanner 3 to which no impact is applied, the first restriction portion 351 and the movable section 31 are shifted from each other, as shown in FIG. 3. In other words, the first restriction portion 351 is provided in a position where it does not overlap with the movable section 31. Therefore, when the movable section 31 swings, the movable section 31 does not come into contact with the first restriction portion 351. As a result, the first restriction portion 351 does not prevent the swing motion of the movable section 31, whereby the movable section 31 can stably swing in the steady state.

In addition, the first restriction portion 351 is unlikely to interfere with the light to be incident on the light reflector M or the light having been reflected off the light reflector M. Therefore, the essential function of the optical scanner 3 (optical scanning) can be ensured, and a large angle of incidence of the light or a large angle of reflection of the light can be achieved, whereby the optical scanner 3 has high flexibility in a possible optical path along which light is deflected.

Further, in the plan view of the optical scanner 3, the first portion 3611 of the impact reduction section 361 preferably partially extends off the first restriction portion 351, as shown in FIG. 3. The positional relationship between the first restriction portion 351 and the impact reduction section 361 allows, when the first portion 3611 comes into contact with the first restriction portion 351, reliable suppression of the displacement of the impact reduction section 361 and prevention of a side effect due to interference between the movable section 31 and the first restriction portion 351. That is, in a case where the entire first portion 3611 extends off the first restriction portion 351 in the plan view, when the impact reduction section 361 is displaced toward the Z-axis side, the first portion 3611 is not allowed to come into contact with the first restriction portion 351 depending on the magnitude of impact applied to the optical scanner 3, but the second portion 3612 may instead come into contact with the first restriction portion 351, possibly resulting in breakage of the impact reduction section 361. On the other hand, in a case where the entire first portion 3611 is hidden behind the first restriction portion 351 in the plan view, the probability of contact between the movable section 31 and the first restriction portion 351 increases depending on the magnitude of impact applied to the optical scanner 3, possibly resulting in breakage of the movable section 31.

The amount of extension of the first portion 3611 off the first restriction portion 351 is not particularly limited to a specific value but is preferably greater than or equal to 1% but smaller than or equal to 90%, more preferably, greater than or equal to 5% but smaller than or equal to 80% of the length of the first portion 3611 in the Y-axis direction in consideration of a sufficient increase in the probability of the contact between the first portion 3611 and the first restriction portion 351.

Further, the first portion 3611 of the impact reduction section 361 according to the present embodiment is a plate-shaped part having a rectangular shape in the plan view, as shown in FIG. 3. It can be said that the thus shaped first portion 3611 is likely to accept the energy of the displacement of the movable section 31, which is formed of a plate-shaped part having a rectangular shape in the plan view, and is therefore likely to restrict the displacement, as shown in FIG. 3. The first portion 3611 does not necessarily have the shape described above and may instead have a square, polygonal, circular, or any other shape.

On the other hand, the second portion 3612 of the impact reduction section 361 according to the present embodiment has an impact absorbing portion 3612a, which has an elongated frame-like shape having a major axis along the X-axis direction in the plan view, a connecting portion 3612b, which connects the impact absorbing portion 3612a to the first portion 3611, and a connecting portion 3612c, which connects the major side of the impact absorbing portion 3612a to the support section 33, as shown in FIG. 3. It can be said that the thus shaped second portion 3612, when it receives compressive force along the Y-axis direction, readily undergoes compressive deformation as shown in FIG. 7A and is therefore likely to absorb the energy of the displacement. The second portion 3612 does not necessarily have the shape described above and may, for example, have a plurality of impact absorbing portions 3612a, a plurality of connecting portions 3612b, which connect the impact absorbing portion 3612a to the first portion 3611, or a plurality of connecting portions 3612c, which connect the impact absorbing portion 3612a to the support section 33.

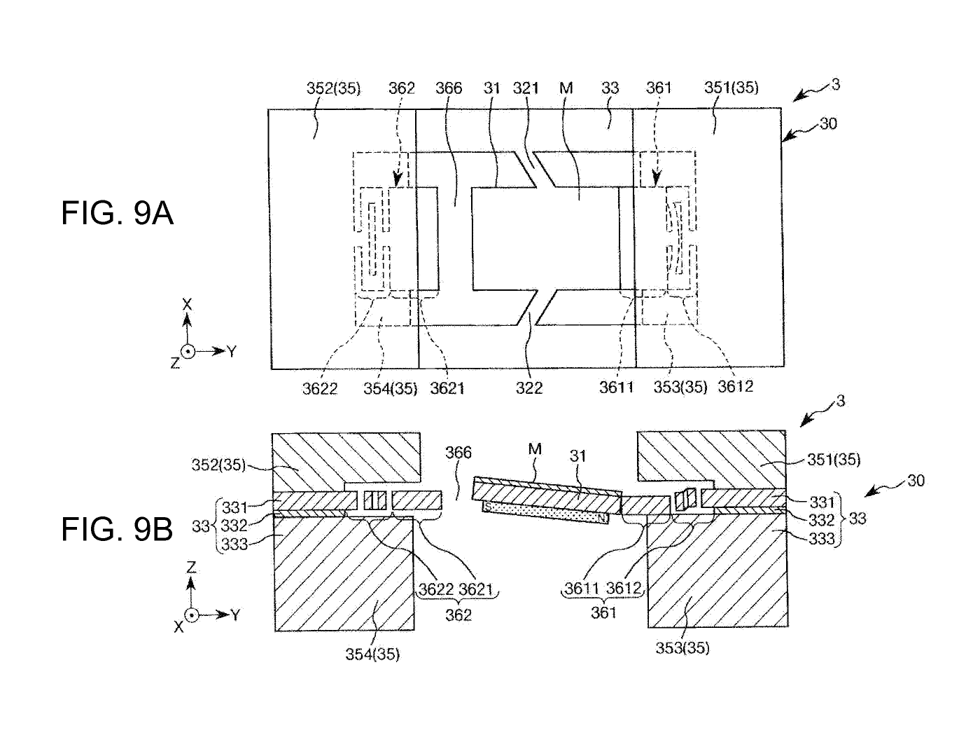

FIGS. 9A and 9B also show an example in which the impact reduction section 361 is displaced in the Z-axis direction, specifically, a case where the end portion of the movable section 31 on the side facing the impact reduction section 361 swings with displacement toward the −Z-axis side. In this example, the impact reduction section 361 is displaced toward the −Z-axis side when the movable section 31 swings, as shown in FIG. 9B. In this process, since the first portion 3611 of the impact reduction section 361 is displaced while the first portion 3611 remains in contact with the swinging movable section 31, the first portion 3611 is displaced by the greatest amount among the portions of the impact reduction section 361 that are concurrently displaced. On the other hand, the second portion 3612 is bent in the Z-axis direction in accordance with the behavior of the first portion 3611.

The first portion 3611 of the impact reduction section 361 having been displaced toward the −Z-axis side then enters the air gap 3533 and eventually comes into contact with the second restriction portion 353, as shown in FIG. 9B. As a result, further displacement of the impact reduction section 361 toward the −Z-axis side is restricted.

The positional relationship between the impact reduction section 361 and the first restriction portion 351 holds true for the positional relationship between the impact reduction section 361 and the second restriction portion 353. That is, in the plan view of the optical scanner 3, the first portion 3611 of the impact reduction section 361 preferably partially extends off the second restriction portion 353, as shown in FIG. 4. The positional relationship between the second restriction portion 353 and the impact reduction section 361 allows, when the first portion 3611 comes into contact with the second restriction portion 353, reliable suppression of the displacement of the impact reduction section 361 and prevention of a side effect due to interference between the movable section 31 and the second restriction portion 353.

The amount of extension of the first portion 3611 off the second restriction portion 353 is the same as the amount of extension of the first portion 3611 off the first restriction portion 351 described above.

The amount of extension of the first portion 3611 off the first restriction portion 351 may be the same as the amount of extension of the first portion 3611 off the second restriction portion 353 but preferably differs therefrom as shown in FIG. 4. In other words, in the plan view of the optical scanner 3, the left end of the first restriction portion 351 (end facing movable section 31) and the left end of the second restriction portion 353 (end facing movable section 31) are preferably shifted from each other, as shown in FIG. 4. In this case, even when the first portion 3611 repeatedly comes into contact with the first restriction portion 351 and the second restriction portion 353, the first portion 3611 comes into contact with the first restriction portion 351 and the second restriction portion 353 in different positions. As a result, a mechanical effect of the contact on the first portion 3611 can be reduced as compared with a case where the contact occurs in the same position, whereby the probability of breakage of the first portion 3611 due to the contact can be lowered.

The first restriction portion 351 and the second restriction portion 353 have been described above. The first restriction portion 352 has the same configuration and function as those of the first restriction portion 351 described above, and the second restriction portion 354 also has the same configuration and function as those of the second restriction portion 353 described above.

The restriction section 35 can be made, for example, of a glass, quartz, silicon, ceramic, metal, or resin material. Among them, when glass, quartz, or any other light transmissive material is used, interference of the restriction section 35 with the light to be incident on the light reflector M does not need to be considered, whereby the first restriction portion 351 and the first restriction portion 352 may, for example, be connected to each other into an integral part. That is, in the plan view of the optical scanner 3, the first restriction portions 351 and 352 may be so configured that they cover and hide the entire impact reduction sections 361 and 362 and the movable section 31.

Further, when the first restriction portion 351 and the first restriction portion 352 are integrated with each other, the integrated first and second restriction portions may have a frame-like shape that does not overlap with the movable section 31 in the plan view. In this case, the rigidity of the first restriction portions 351 and 352 can be increased, whereby the impact resistance of the entire optical scanner 3 can be increased.

### Second Embodiment

An image display apparatus according to a second embodiment of the invention will next be described.

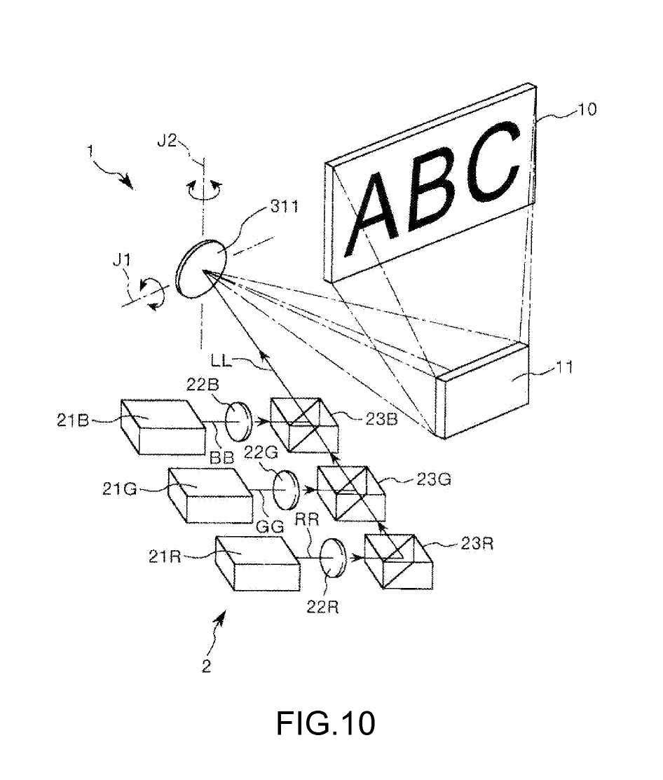

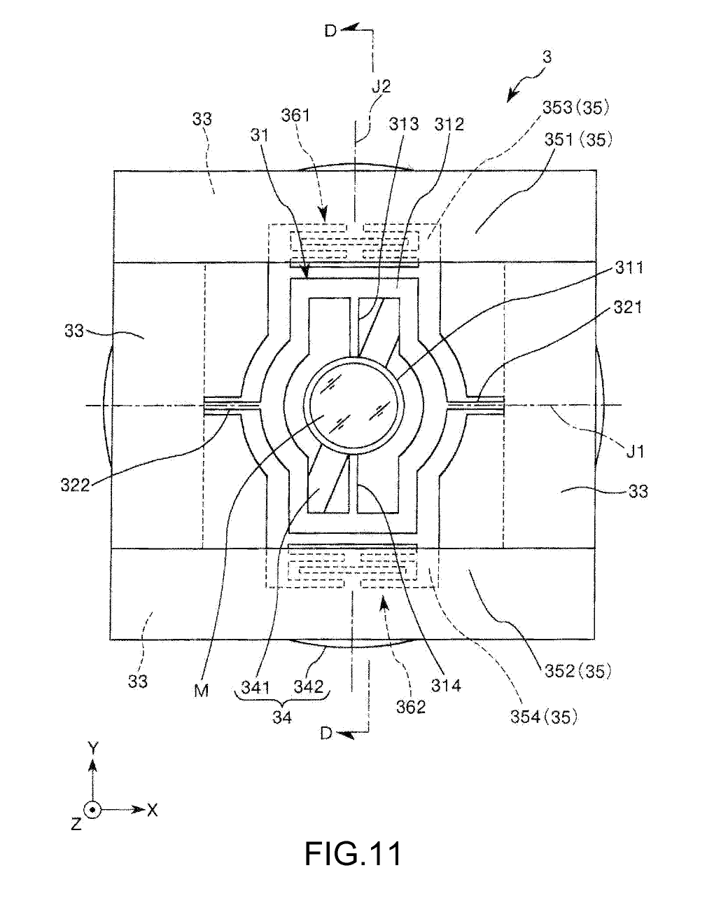

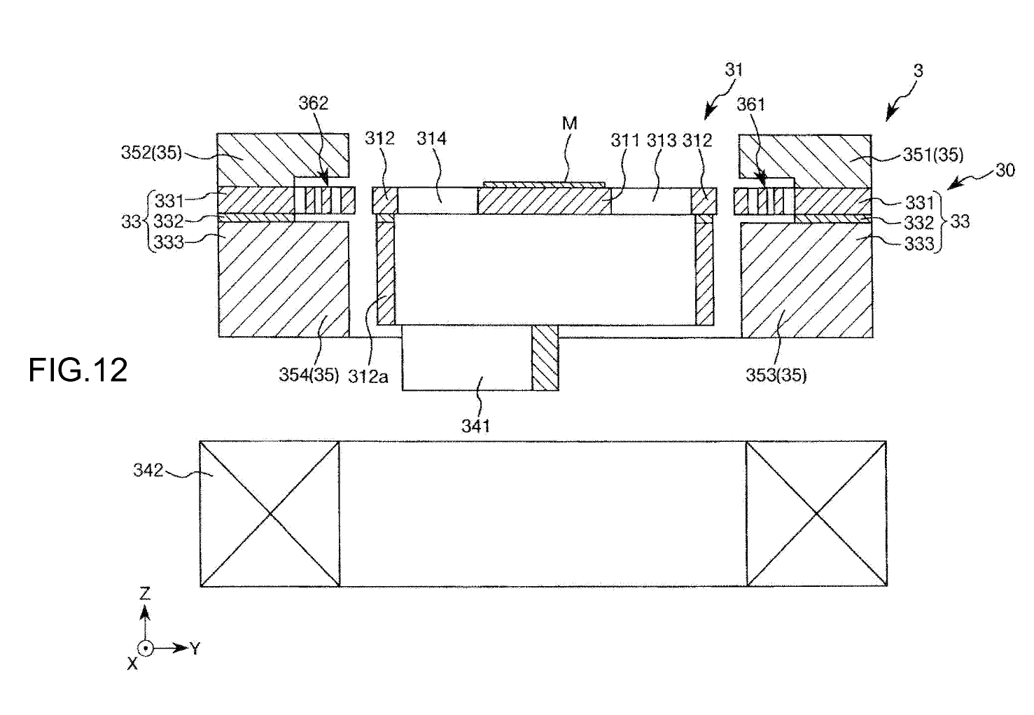

FIG. 10 is a configuration diagram showing the image display apparatus according to the second embodiment of the invention. FIG. 11 is a top view of an optical scanner provided in the image display apparatus shown in FIG. 10. FIG. 12 is a cross-sectional view taken along the line D-D in FIG. 11.

The image display apparatus according to the second embodiment will be described below primarily on differences from the embodiment described above, and the same items will not be described.

The image display apparatus according to the second embodiment of the invention is the same as the image display apparatus according to the first embodiment except that the optical scanners are configured differently. The same configurations as those in the embodiment described above have the same reference characters.

An image display apparatus 1 according to the present embodiment includes a drawing light source unit 2, which outputs drawing laser light LL, an optical scanner 3, which scans an object with the drawing laser light LL, and a mirror 11, which reflects the drawing laser light LL deflected by the optical scanner 3, as shown in FIG. 10. The mirror 11 may be provided as required and may be omitted.

### Drawing Light Source Unit

The drawing light source unit 2 has the same configuration as that in the first embodiment described above, and no description thereof will therefore be made.

### Optical Scanner

The optical scanner 3 according to the present embodiment has a function of two-dimensionally scanning an object with the drawing laser light LL outputted from the drawing light source unit 2.

The optical scanner 3 includes a movable section 31, which has a light reflector M, a support section 33, which is so disposed that it surrounds the movable section 31, shafts (first shafts) 321 and 322, which connect the movable section 31 and the support section 33 to each other and support the movable section 31 in a swingable manner around a first axis J1, a pair of impact reduction sections 361 and 362, a drive unit 34, which causes the movable section 31 to swing, and a restriction section 35, which restricts excessive displacement of the impact reduction sections 361 and 362, as shown in FIG. 11.

The movable section 31 has a first movable portion 311, which has an upper surface on which the light reflector M is provided, a frame-shaped second movable portion 312, which is so disposed that it surrounds the first movable portion 311, and a pair of shafts (second shafts) 313 and 314, which connect the first movable portion 311 and the second movable portion 312 to each other and support the first movable portion 311 in a swingable manner around a second axis J2 perpendicular to the first axis J1. The pair of shafts 313 and 314 are disposed on opposite sides of the first movable portion 311 and extend in the direction along the second axis J2.

Further, a rib 312a is provided on the lower surface of the second movable portion 312, and a permanent magnet 341 is disposed on the lower surface of the rib 312a, as shown in FIG. 12. The rib 312a has a function as a reinforcing portion that reinforces the mechanical strength of the second movable portion 312 and a function as a gap member that provides a space between the first movable portion 311 and a permanent magnet 341 to prevent them from coming into contact with each other. The permanent magnet 341 has a rod-like shape having an S pole at one end and an N pole at the other end and is so disposed that it is inclined to the first and second axes J1, J2 in the plan view.

Further, the impact reduction sections 361 and 362 are connected to an inner portion of the frame-shaped support section 33 and disposed on opposite sides of the movable section 31 in the Y-axis direction, as shown in FIG. 12.

The impact reduction sections 361 and 362 therefore prevent direct contact of the movable section 31 with the support section 33 and restrict excessive displacement of the movable section 31 in the Y-axis direction to prevent breakage of the shafts 321 and 322 and other portions.

The restriction section 35 includes first restriction portions 351 and 352 and second restriction portions 353 and 354. The restriction section 35 can therefore prevent breakage of the impact reduction sections 361 and 362 due to excessive displacement thereof in the Z-axis direction.

In the thus configured optical scanner 3, the first movable portion 311, the shafts 313 and 314, the second movable portion 312, the shafts 321 and 322, and the permanent magnet 341 form a first oscillation system that cause the first movable section 311 to swing around the first axis J1. Further, the first movable portion 311 and the shafts 313 and 314 form a second oscillation system that causes the first movable portion 311 to swing around the second axis J2.

Causing the first movable portion 311 to swing around the second axis J2 relative to the second movable portion 312 and causing the second movable portion 312 to swing around the first axis J1 relative to the support section 33 allow the first movable portion 311 to swing around the two axes or the first and second axes J1, J2. In the present embodiment, the optical scanner 3 is so disposed that the swing motion of the first movable portion 311 around the first axis J1 allows vertical scanning (secondary scanning) using the drawing laser light LL and the swing motion of the first movable portion 311 around the second axis J2 allows horizontal scanning (primary scanning) using the drawing laser light LL.

A coil 342 is provided below the permanent magnet 341, and when a first alternate voltage for causing the first oscillation system to swing and a second alternate voltage for causing the second oscillation system to swing is applied in the form of a superimposed voltage produced by superimposing them on each other to the coil 342, the first movable portion 311 is allowed to swing around the two axes or the first and second axes J1, J2. The first alternate voltage is not particularly limited to a specific voltage and can, for example, be the same alternate voltage applied to the vertical-scan optical scanner 3″ in the first embodiment described above, and the second alternate voltage is not particularly limited to a specific voltage and can, for example, be the same alternate voltage applied to the horizontal-scan optical scanner 3′ in the first embodiment described above. In this case, it is preferable that the first oscillation system undergoes non-resonant oscillation and the second oscillation system undergoes resonant oscillation.

The optical scanner 3 according to the present embodiment has been described above. Since the two-dimensional-scan optical scanner 3 in the present embodiment, which forms a gimbal-shaped device, allows two-dimensional scanning by itself using the drawing laser light LL, the size of the apparatus can be reduced and alignment adjustment is readily made as compared, for example, with the first embodiment described above, in which two one-dimensional-scan optical scanners are combined with each other for two-dimensional scanning using the drawing laser light LL.

The second embodiment described above can provide the same advantageous effects as those provided by the first embodiment described above.

### Third Embodiment

An image display apparatus according to a third embodiment of the invention will next be described.

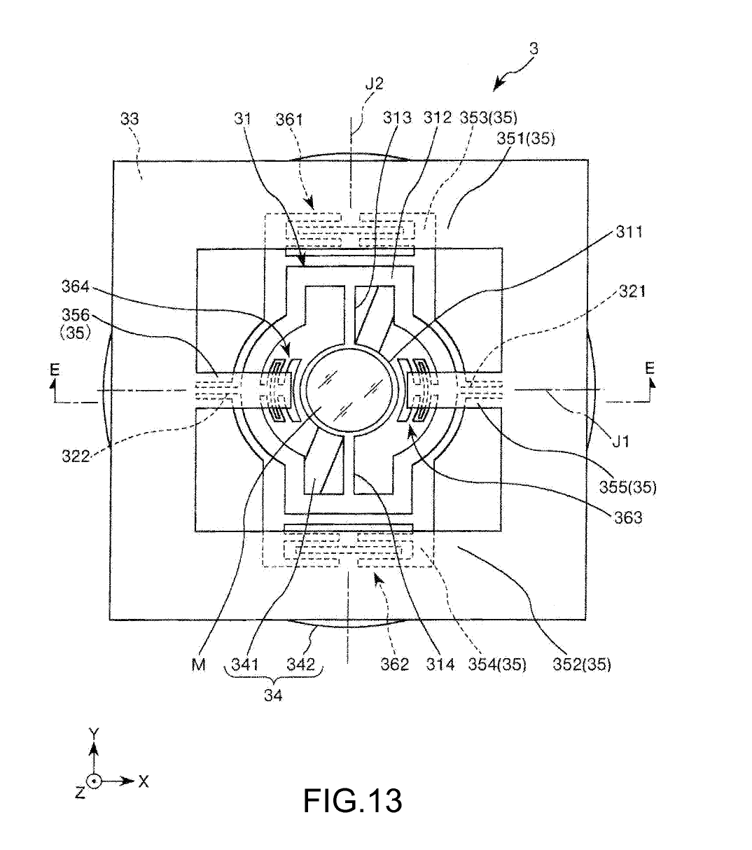

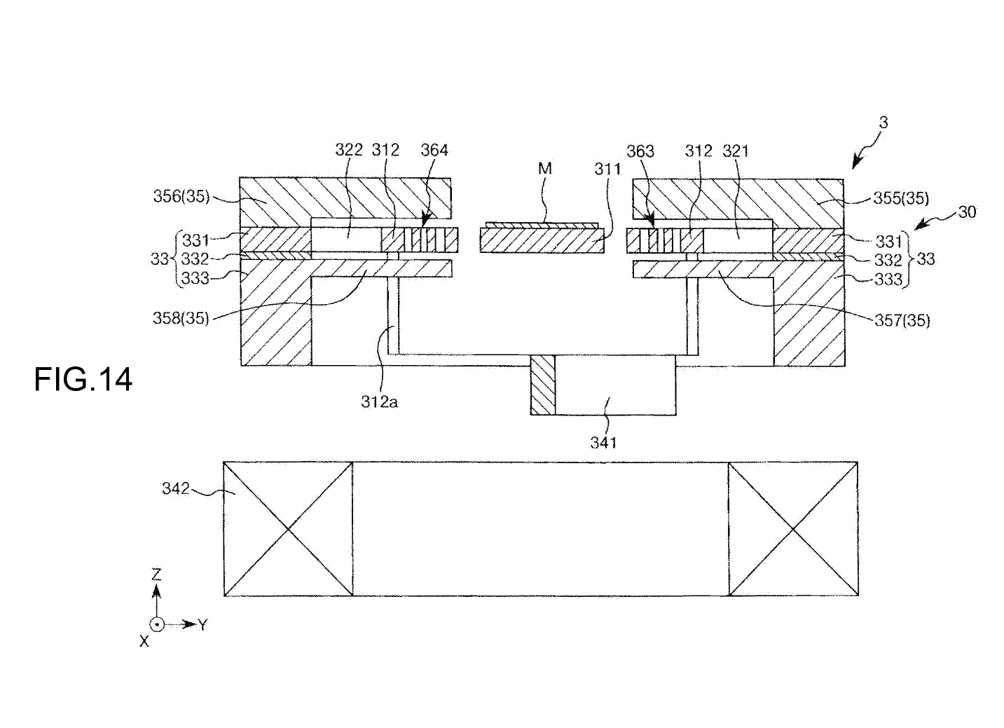

FIG. 13 is a top view of an optical scanner provided in the image display apparatus according to the third embodiment of the invention. FIG. 14 is a cross-sectional view taken along the line E-E in FIG. 13.

The image display apparatus according to the third embodiment will be described below primarily on differences from the embodiments described above, and the same items will not be described.

The image display apparatus according to the third embodiment of the invention is the same as the image display apparatus according to the second embodiment except that the optical scanner is configured differently. The same configurations as those in the embodiments described above have the same reference characters.

### Optical Scanner

An optical scanner 3 according to the present embodiment further includes impact reduction sections 363 and 364, which are provided on opposite sides of the first movable portion 311 in the X-axis direction as well as the impact reduction sections in the Y-axis direction, as shown in FIG. 13. The impact reduction sections 363 and 364 are so provided that one end of each of them is connected to the second movable portion 312 and they extend from the second movable portion 312 toward the first movable portion 311. When the first movable portion 311 is displaced in the X-axis direction due, for example, to external impact, the first movable portion 311 comes into contact with the impact reduction section 363 or 364, whereby further displacement of the first movable portion 311 in the X-axis direction is restricted. The impact reduction sections 363 and 364 have the same configuration as that of the impact reduction sections 361 and 362 except the arrangement and shape thereof.

A restriction section 35 provided in the optical scanner 3 according to the present embodiment includes not only first restriction portions 351 and 352 but also first restriction portions 355 and 356 and not only second restriction portions 353 and 354 but also second restriction portions 357 and 358. A rib 312a is provided on the lower surface of the second movable portion 312 and includes through holes and cutouts in correspondence with the positions of the second restriction portions 357 and 358 in such a way that the rib 312a does not interfere with the second restriction portion 357 or 358.

The first restriction portions 351 and 352 have a function of restricting excessive displacement of the impact reduction sections 361 and 362 in the Z-axis direction (toward +Z-axis side). On the other hand, the first restriction portions 355 and 356 have a function of restricting excessive displacement of the impact reduction sections 363 and 364 in the Z-axis direction (toward +Z-axis side).

The first restriction portions 351 and 352 are preferably so configured that part of the impact reduction sections 361 and 362 extends off the first restriction portions 351 and 352 in the plan view, as in the second embodiment. On the other hand, the first restriction portions 355 and 356 are preferably so configured that part of the impact reduction sections 363 and 364 extends off the first restriction portions 355 and 356. Each of the first restriction portions 355 and 356 shown in FIG. 13 has a rod-like shape extending along the X axis. Therefore, when the second movable portion 312 swings, the second movable portion 312 is unlikely to come into contact with the first restriction portion 355 or 356, whereby interference of the swing motion of the second movable portion 312 is avoided. That is, the first restriction portions 355 and 356, depending on the shape thereof, could come into contact with the swinging second movable portion 312 and prevent the swing motion thereof, but the rod-like shape along the X axis described above is likely to prevent the contact with the second movable portion 312 (the same holds true for the second restriction portions 357 and 358, which will be described later).

The first restriction portions 351, 352, 355, and 356 may be parts separate from each other, but in the present embodiment, the first restriction portions 351, 352, 355, and 356 are formed integrally with each other with those adjacent to each other connected to each other. The first restriction portions 351, 352, 355, and 356 can therefore be handled as a single member having substantially a frame shape in the plan view.

The second restriction portions 353 and 354 have a function of restricting excessive displacement of the impact reduction sections 361 and 362 in the Z-axis direction (toward −Z-axis side). On the other hand, the second restriction portions 357 and 358 have a function of restricting excessive displacement of the impact reduction sections 363 and 364 in the Z-axis direction (toward −Z-axis side).

The second restriction portions 353 and 354 are preferably so configured that part of the impact reduction sections 361 and 362 extends off the second restriction portions 353 and 354 in the plan view, as in the second embodiment. On the other hand, the second restriction portions 357 and 358 are preferably so configured that part of the impact reduction sections 363 and 364 extends off the second restriction portions 357 and 358. The second restriction portions 353, 354, 357, and 358 according to the present embodiment have substantially the same shapes as those of the first restriction portions 351, 352, 355, and 356 in the plan view but may differ therefrom.

The second restriction portions 353, 354, 357, and 358 are formed integrally with the support section 33, as in the first embodiment. The second restriction portions 357 and 358 are so configured that they protrude from the support section 33 but may instead be so configured that they protrude from the rib 312a.

According to the thus configured optical scanner 3, the four impact reduction sections 361 to 364 effectively reduce impact applied to the movable section 31 both in the X-axis and Y-axis directions, whereby impact resistance can be increased. Further, the four first restriction portions 351, 352, 355, and 356 and the four second restriction portions 353, 354, 357, and 358 prevent excessive displacement of the impact reduction sections 361 to 364 in the Z-axis direction to prevent breakage of the impact reduction sections 361 to 364, whereby the impact resistance can be increased also from this point of view.

The third embodiment described above can provide the same advantageous effects as those provided by the first and second embodiments described above.

### 2. Head-Up Display

A head-up display that is an example of the image display apparatus according to any of the embodiments of the invention will next be described.

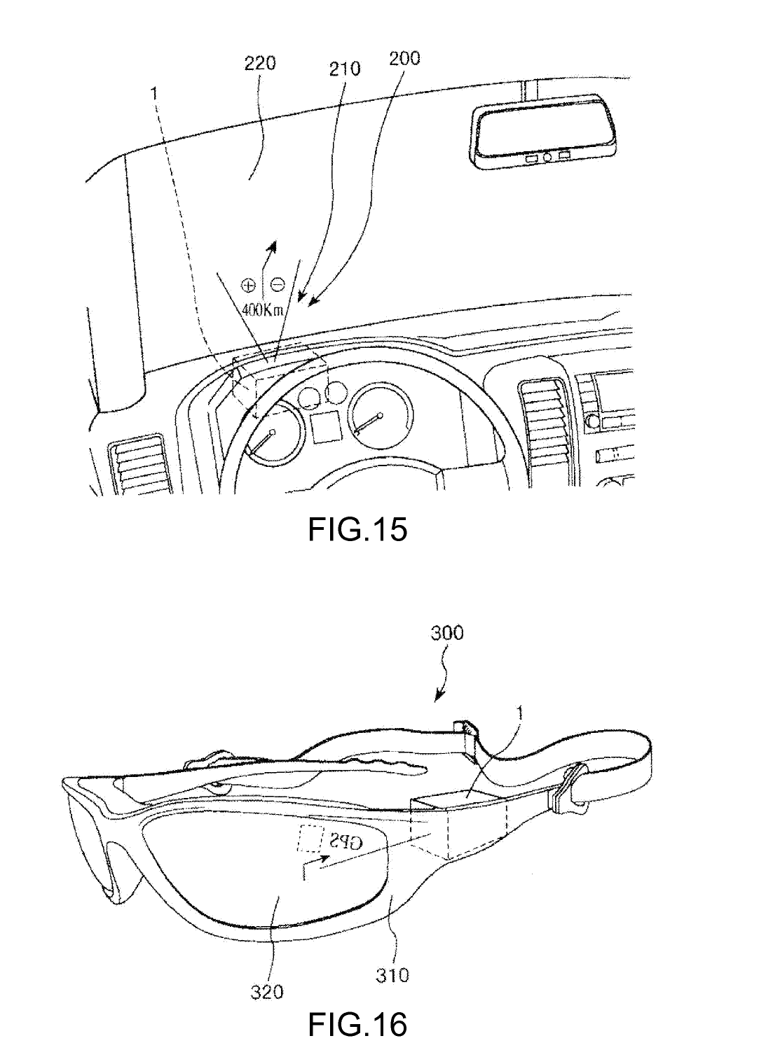

FIG. 15 is a perspective view showing a head-up display that is an application of the image display apparatus according to any of the embodiments of the invention.

In a head-up display system 200, the image display apparatus 1 is so incorporated in a dashboard of an automobile that the image display apparatus 1 forms a head-up display 210, as shown in FIG. 15. The head-up display 210 can, for example, display a predetermined image, such as an image displayed as a guide to a destination, on a windshield 220. The head-up display system 200 can be employed, for example, in an airplane, a ship, and other vehicles as well as an automobile.

### 3. Head-Mounted Display

A head-mounted display according to an embodiment of the invention will next be described.

FIG. 16 is a perspective view showing the head-mounted display according to the embodiment of the invention.

A head-mounted display 300 includes a frame 310, which is worn around the head of a viewer, and the image display apparatus 1, which is incorporated in the frame 310, as shown in FIG. 16. The image display apparatus 1 displays a predetermined image visually recognized with one of the eyes on a display section (light reflection layer member) 320, which is provided in a portion of the frame 310 where a lens is originally disposed.

The display section 320 may be transparent or opaque. When the display section 320 is transparent, information from the image display apparatus 1 can be superimposed on and used with information from the outside environment. The display section 320 only needs to reflect at least part of light incident thereon and can, for example, be a half-silvered mirror.

The head-mounted display 300 may be provided with two image display apparatus 1 so that two display sections display images visually recognized by the two eyes.

The actuator, the optical scanner, the image display apparatus, and the head-mounted display according to the embodiments of the invention have been described with reference to the drawings, but the invention is not limited thereto. The configuration of each portion can be replaced with an arbitrary configuration having the same function. Further, other arbitrary components may be added to the embodiments of the invention.

The entire disclosure of Japanese Patent Application No. 2014-038181, filed Feb. 28, 2014 is expressly incorporated by reference herein.

What is claimed is:

1. An actuator comprising:
a movable section;
a support section;
a first shaft that connects the movable section and the support section to each other and supports the movable section in a swingable manner around a first axis;
an impact reduction section that is provided between the movable section and the support section and connected to the support section; and
a restriction section so provided that the restriction section sandwiches the impact reduction section in a displacement direction in which the movable section is displaced when the movable section swings around the first axis.

2. The actuator according to claim 1,
wherein the restriction section restricts displacement of the impact reduction section in the displacement direction.

3. The actuator according to claim 1,
wherein when a flat plane including the first axis and the impact reduction section is defined to be a reference plane, the restriction section is provided in a position where the restriction section does not overlap with the movable section in a plan view viewed in a direction perpendicular to the reference plane.

4. The actuator according to claim 1,
wherein the impact reduction section includes a first portion and a second portion that has bending rigidity smaller than the bending rigidity of the first portion and connects the first portion to the support section.

5. The actuator according to claim 4,
wherein when a flat plane including the first axis and the impact reduction section is defined to be a reference plane, part of the first portion extends off the restriction section in a plan view viewed in a direction perpendicular to the reference plane.

6. The actuator according to claim 1,
wherein the movable section, the support section, the first shaft, and the impact reduction section are formed integrally with each other.

7. The actuator according to claim 1,
wherein the movable section has a first movable portion, a second movable portion that has a frame-like shape that surrounds the first movable portion, and a second shaft that connects the first movable portion to the second movable portion and supports the first movable portion in a swingable manner relative to the second movable portion around a second axis that intersects the first axis.

8. An optical scanner comprising:
a movable section including a light reflector that reflects light;
a support section;
a first shaft that connects the movable section and the support section to each other and supports the movable section in a swingable manner around a first axis;
an impact reduction section that is provided between the movable section and the support section and connected to the support section; and
a restriction section so provided that the restriction section sandwiches the impact reduction section in a displacement direction in which the movable section is displaced when the movable section swings around the first axis.

9. An image display apparatus comprising:
the optical scanner according to claim 8.

10. A head-mounted display comprising:
a frame worn around a head of a viewer; and
the optical scanner according to claim 8 provided in the frame.
